(19) United States
(12) Patent Application Publication
(10) Pub. No.: US 2006/0227031 A1
(43) Pub. Date: Oct. 12, 2006

(54) Remote control device protector

(76) Inventor: Dean L. Benbow, Winston- Salem, NC (US)

Correspondence Address: DARCELL WALKER, 8107 CARVEL LANE, HOUSTON, TX, 77036, US

(21) Appl. No.: 11/103,749

(22) Filed: Apr. 12, 2005

(51) Int. Cl. G08C 19/12

(52) U.S. Cl. 341/176

(57) ABSTRACT

A cover protects a remote control device from damage that can result from a sudden impact such as dropping the device. This cover particularly protects the portion of a remote that directly or indirectly engages one or more keys. The typical remote control device that is used in combination with key(s) to control an apparatus such as a car has an opening through which a key chain extends to attach the key(s) to the fob. This cover made of flexible compressible material houses a remote control device and extends to enclose the bridge portion of the remote control device. An opening in the housing facilitates engagement of the remote control device with one or more keys. This protective cover protect the weakest portion of the remote control device, the bridge, from sudden impact against hard surfaces.

### FIELD OF THE INVENTION

This invention relates to a protector for a remote control device and in particular to a cover for a remote control key fob device and more particular to a protector for the neck/bridge section of the control device that engages the key chain.

### BACKGROUND OF THE INVENTION

Keyless remote entry has become prevalent in its inclusion in new vehicle accessories. More specifically, the use of key fob type mechanisms which allow for the locking and unlocking of vehicle door lock systems, the opening of truck latch mechanisms and the setting and unsetting of alarm systems has become commonplace in new vehicle accessories. High end, as well as low end, vehicles are including the above noted functions as well as other functions in standard accessory packages. In this manner, the importance of the protection of remote keyless entry key fobs is rising.

As the public begins to rely more on more on these key fobs systems, it becomes imperative to protect and preserve the electrical circuitry of these devices. The introduction of moisture either by rain, mist or inadvertent dropping in water puddles near the vehicle inevitably occurs in common use of the key fobs. The introduction of foreign particle such as dust, dirt and sand also occurs through common use and over time begins to degrade if not completely hinder the normal operation of the key fob. In addition, as the key fob is often, if not entirely kept along with the car keys and other house keys, the common use also entails inadvertent dropping, knocking banging and hitting the key fob against hard objects. This continuous physical shock to the key fob over time begins to degrade if not completely hinder the normal operation of the key fob.

Several device exist that attempt to address the problem of protecting the remote key fob/control devices. Protective cases for remote control transmitters are known to be made from flexible material such as leather and vinyl. Remote control transmitters are well known for having buttons and/or switches that control car alarms, personal alarms, garage door openers, automobile trunk releases and various household electronics such as a television.

As an example, U.S. Pat. No. 4,951,817 shows a receptacle case 18 FIG. 1 formed out of protective material, such as leather, vinyl, or cloth, which is used for protecting electronic beeper, buttons.

Protective covers have also been used for other hand-held devices such as calculators. As an example, U.S. Pat. No. 4,165,554 discloses an assembly comprising a calculator with buttons on one side a sliding cover, which can be attached either to the front or the back. However, there is no separate container for this cover and the cover itself is not clear. Further, there are no modifications for using this cover with a remote control transmitter.

U.S. Pat. No. 5,338,691 describes a case protecting the buttons of and supporting a remote control transmitter, the transmitter including an opening to receive a key chain ring, the case further including a container and a rigid clear plastic cover-panel that is slidable by one's thumb. The cover-panel is fitted within two side grooves tapered only at rear ends in the container and also includes a catch that prevents the cover-panel from sliding completely off the container in a forward direction. The container includes an indentation notch on one side end wall that allows the catch to pass there through when sliding the cover-panel completely off the container in the rearward direction. There is also provided a second opening in the container that permits the transmitter's key chain ring opening to pass there through. The case protects the buttons of the transmitter. The transmitter can be one that activates personal or auto alarms, opens and closes garage doors or gates, unlocks an automobile trunk, or controls household electronics.

U.S. Pat. No. 6,669,017 describes a protective cover for a remote keyless entry key fob having at least one communication button, the protective cover including a body section having a first side and an oppositely disposed second side, and a cavity defined by the body section adapted to receive the key fob, wherein at least one of the first or second sides includes an aperture such that the key fob is accessible through the aperture and an “O” ring disposed between the key fob and the protective cover for providing a press fit connection between the protective cover and the key fob such that the key fob is positively located within the protective cover.

Although these many devices protect various types of remote control devices, these devices protect the body of the controller, but not the bridge/neck portion that engages a key chain. If the controller is dropped and strikes a hard surface on the bridge, this unprotected bridge could easily break. If the bridge is broken, the user could no longer attach a set of keys to the controller. In addition, there is a substantial cost to replace this type of controller.

Consequently, a need exists for a protective cover for the remote keyless entry key fob. A system that will allow full implementation of all the communication buttons on the system while still providing protection for the entire controller device including the bridge portion that engages a key chain.

### SUMMARY OF THE INVENTION

It is an objective of the invention to provide an improved device for covering and protecting remote control devices.

It is a second objective of the invention to provide a remote control protection device that covers the bridge of the controller device that engages a key chain.

It is a third objective of the present invention to provide a flexible remote control protective device.

It is a fourth objective of the present invention to provide a protective device for a remote controller that absorbs shocks when the controller is dropped or suddenly strikes a hard surface.

The present invention provides a cover for a remote control device such as a key fob. This cover protects the remote control from damage that can result from a sudden impact such as dropping the device. The present invention particularly protects the portion of a remote that directly or indirectly engages one or more keys. The typical remote control device that is used in combination with key(s) to control an apparatus such as a car has an opening through which a key chain extends to attach the key(s) to the fob. This section will be referred to as the bridge. If the remote control device drops and the bridge portion strikes a hard surface, the cover of the present invention will protect the bridge portion as well as the entire remote control device.

The present invention comprises a housing flexible, stretchable and compressible material such as leather. The housing extends over and encloses the remote control device. One side of the housing is open to enable the user to see and operate the control buttons. The housing also has an opening for attachment of the key or key chain.

### DESCRIPTION OF THE DRAWINGS

FIG. 1 shows a conventional remote control device known as a key fob with a bridge section for attaching one or more keys to the device.

FIG. 2 shows an embodiment of the present invention having a cover over the bridge section of the remote control device.

FIG. 3 shows a back side view of the remote control cover of the present invention.

FIG. 4 shows an alternate embodiment of the present invention having a separate section that engages one or more keys.

FIG. 5 shows an embodiment of the present invention having a separate opening to facilitate the use of engaging one or more keys

FIG. 6 shows an embodiment of the present invention having a clear cover on one side of the invention enabling the user to see and press the buttons on the remote control.

FIG. 7 shows an embodiment of the present invention containing the remote control device.

### DETAILED DESCRIPTION OF THE INVENTION

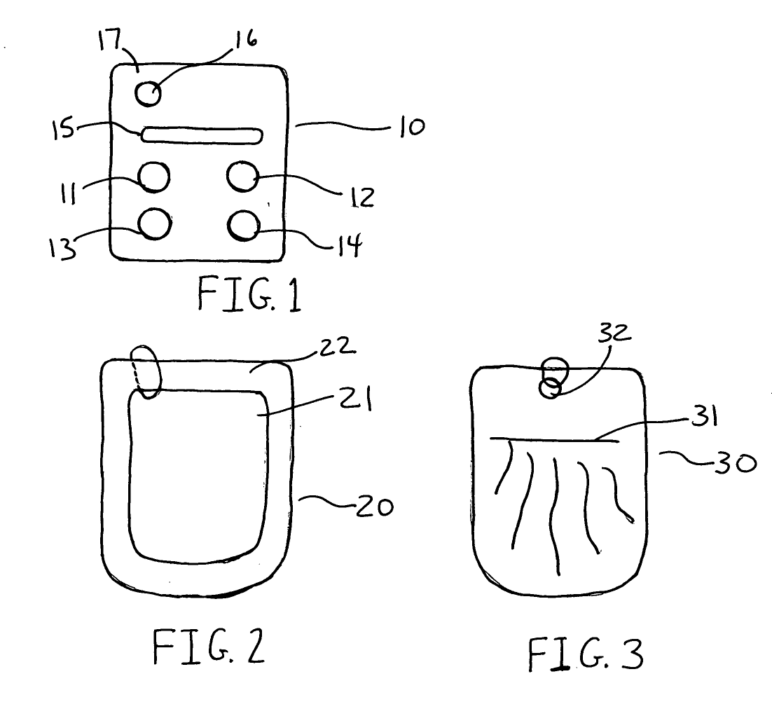

Referring to FIG. 1, shown is a typical key fob 10 that can be used in the implementation of the present invention. The key fob is a small device that is attached to the key chain along with the user's keys. Many conventional key fobs have controls that enable the user to remotely lock and unlock doors. The key fob of the present invention can have multiple buttons that are pressed to enact certain functions related to locks on a house, car or other facility. The key fob of the present invention can have buttons 11 and 12 that function to lock and unlock a door respectively. Buttons 13 and 14 are optional buttons each of which can control the opening or closing of doors. This feature is implemented primarily on motor vehicles such as mini vans. A panic bar 15 implements an alarm or other distress function. Also shown is an opening 16 through which a key chain can extend to attach one or more keys to the remote control device. This portion of the remote immediately around the opening 16 will be referred to as the bridge 17 of the remote control. With this opening so close to the edge of the remote control, the bridge is the weakest section of the remote housing. A sudden impact of the remote control at the bridge section 17 could easily cause the bridge to break. Presently, there is no way to repair a broken bridge of a remote control device. Users will need to purchase an entirely new remote control device.

FIG. 2 shows an embodiment of the present invention that provides a protective cover for the remote control device including the bridge section of the remote control device. This cover 20 comprises a housing flexible, stretchable and compressible material such as leather. The flexible and stretchable characteristics enable the housing to fit snuggly around the remote control device with little difficulty. The compressible characteristic enables the cover to absorb shock from a sudden impact. This ability to absorb shock protects the remote control device. Most covers do not protect the remote control and reduce shock to the remote control in this manner. Flexible remote control protectors do not protect and shield the bridge portion of the remote control device. The housing extends over and encloses the remote control device. The front side of the housing 21 is open to enable the user to see and operate the control buttons. This opening can also facilitate the attachment of one or more keys to the remote control via key chain device.

The back side 30 of the cover, shown in FIG. 3, can also have a slot 31 or other form of opening 32 to further facilitate the attachment of one or more keys to the remote control via key chain device. The back side can have one or more openings. This opening can also be located on the top portion 22 of the cover to facilitate attachment of one or more keys to the remote control via key chain device. The slot 31 can also be the opening through which a remote control device can be inserted into the cover.

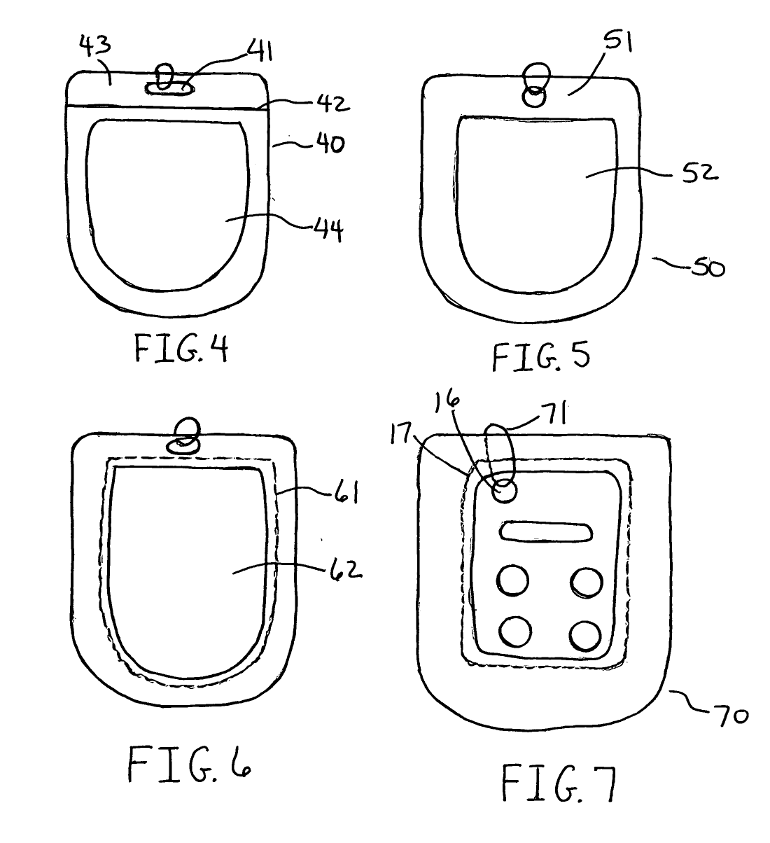

FIG. 4 shows an embodiment of the cover 40 of the present invention in which the opening 41 that engages the key chain is in a completely separate section of the cover. A divider 42 such as stitching can seal off the engagement section 43 from the cover section 44. With this embodiment, the entire remote control device is housed in the section 44 of the cover.

FIG. 5 shows an embodiment of the present remote control cover 50 in which a separate engagement section 51 exist for engaging a key chain and attaching one or more keys to the cover. In this embodiment, the engagement section 51 is not separated from the cover section 52, as is the case in FIG. 4.

FIG. 6 shows the embodiment of FIG. 5 further having a clear plastic cover 61 over the front side opening 62. This plastic cover can be implemented in any embodiment of the present invention to enable to the user see the control buttons.

FIG. 7 shows an embodiment of the present invention containing the remote control device. This figure shows the remote control device in an embodiment of the cover 70 that is described in FIG. 2. A key chain 71 extends through the opening 16 in the remote control device and through an opening in the backside of the cover as previously described. In this view, the bridge 17 of the remote control device is completely covered and protected to prevent damage to the remote control device from a sudden impact on the bridge or any other portion of the remote control device. In this embodiment, there can also be a plastic cover over the front side opening of the protective cover.

The device of this invention provides significant advantages over the current art. The invention has been described in connection with its preferred embodiments. However, it is not limited thereto. Changes, variations and modifications to the basic design may be made without departing from the inventive concepts in this invention. In addition, these changes, variations and modifications would be obvious to those skilled in the art having the benefit of the foregoing teachings. All such changes, variations and modifications are intended to be within the scope of this invention.

I claim:

1. A protective cover for a remote control device that is used in combination with one or more keys to operate an apparatus, the protective cover comprising:
a flexible, stretchable, compressible housing that encloses the entire remote control device such that any portion of the remote control device that directly or indirectly engages and attaches the one or more keys to the remote control device is protected, said protective cover having a front side and a back side, the front side having an open section such that a user can access buttons on the remote control device which the device is enclosed in the protective cover.

2. The protective cover as described in claim 1 wherein an attachment device for attaching one or more keys to said cover extends through the open section of the front side and through an opening on the back side of protective cover.

3. The protective cover as described in claim 1 wherein an attachment device for attaching one or more keys to said cover extends through the open section of the front side and through a second opening on the front side of protective cover.

4. The protective cover as described in claim one further comprising a clear cover over the open section on the front side of the cover.

5. The protective cover as described in claim 1 further comprising a top section of the cover divided from both said front and back covers, the top section having an opening to facilitate engagement of an attaching means to attach said cover to one or more keys.

6. The protective cover as described claim 5 wherein a threaded stitch separates said top section from said front and back sections.

7. The protective cover as described in claim 1 wherein the flexible, stretchable, compressible housing comprises a leather material.

8. The protective cover as described in claim 1 further comprising a top section of the cover connected in open space to both said front and back covers, the top section having an opening to facilitate engagement of an attaching means to attach said cover to one or more keys.
